(19) United States
(12) Patent Application Publication
(10) Pub. No.: US 2025/0299349 A1
(43) Pub. Date: Sep. 25, 2025

(54) METHOD AND APPARATUS FOR DETECTING TRANSPARENT OBSTACLE BASED ON ARTIFICIAL INTELLIGENCE

(71) Applicants: Hyundai Motor Company, Seoul (KR); Kia Corporation, Seoul (KR)

(72) Inventor: SuHyun Yoon, Hwaseong-Si (KR)

(21) Appl. No.: 18/910,470

(22) Filed: Oct. 9, 2024

(30) Foreign Application Priority Data
Mar. 20, 2024 (KR) 10-2024-0038552

(51) Int. Cl. G06T 7/50; G05D 1/622; G05D 111/10; G06T 7/80; G06V 10/24; G06V 10/75; G06V 10/762

(52) U.S. Cl. CPC G06T 7/50; G05D 1/622; G06T 7/80; G06V 10/24; G06V 10/751; G06V 10/762; G05D 2111/14; G06T 2207/10028; G06T 2207/10048; G06T 2207/20081; G06T 2207/30261

(57) ABSTRACT

An apparatus for detecting a transparent obstacle based on artificial intelligence may include an RGB-Depth camera configured to generate an RGB image and a depth image, a thermal imaging camera configured to generate a thermal image, and a controller connected to the RGB-depth camera and the thermal imaging camera synchronized with each other, where the controller may be configured to align the RGB image and the depth image with respect to the thermal image, to generate an aligned RGB image, an aligned depth image and an aligned thermal image, detect a pixel region determined as the transparent obstacle by using an artificial intelligence model based on the aligned RGB image and the aligned thermal image, and estimate the depth of the transparent obstacle by using the aligned depth image and the detected pixel region when the pixel region determined as the transparent obstacle is detected.

### CROSS-REFERENCE TO RELATED APPLICATIONS

The present application claims priority to Korean Patent Application No. 10-2024-0038552, filed Mar. 20, 2024, the entire contents of which is incorporated herein for all purposes by this reference.

### TECHNICAL FIELD

The present disclosure relates to an apparatus and method for detecting a transparent obstacle based on artificial intelligence. More particularly, the present disclosure relates to an apparatus and method for detecting a transparent obstacle based on artificial intelligence, capable of detecting the transparent obstacle such as a glass door if a robot is driving.

### BACKGROUND

A mobile robot may move along a designated path or autonomously drive in a given environment. Mobile robots may be used in various industry and service fields, and may appear in various forms such as a vehicle, a drone, an intelligent robot, or the like. The core goal of a mobile robot may be to detect and recognize the environment and safely reach the target point.

Depth and LiDAR sensors that may be used in conventional technologies for robot driving and obstacle detection may not recognize transparent objects such as glass as obstacles. If the robot may not detect the transparent object while driving, there may be a risk of collision while driving. Unlike visible light and near-infrared light, long-wave infrared (LWIR) from thermal imaging cameras may not pass through glass.

### SUMMARY

The present disclosure attempts to provide an apparatus and method for detecting a transparent obstacle based on artificial intelligence capable of configuring a vision system by using an RGB-depth camera and a thermal imaging camera, detecting a transparent obstacle through a deep learning with an input of information obtained by the vision system, and enabling a robot to detour around the detected transparent obstacle if applied to a mobile robot.

An apparatus for detecting a transparent obstacle may comprise a red-green-blue-depth (RGB-Depth) camera configured to generate at least one image associated with the transparent obstacle, wherein the at least one image comprises red-green-blue (RGB) data and depth data; a thermal imaging camera configured to generate a thermal image associated with the transparent obstacle; and a controller coupled to the RGB-depth camera and the thermal imaging camera synchronized with each other, wherein the controller is configured to: align the at least one image and the thermal image; detect, based on the aligned at least one image and the aligned thermal image, a pixel region determined as the transparent obstacle by using an artificial intelligence model; and estimate, based on the detected pixel region and based on the depth data of the aligned at least one image, a depth of the transparent obstacle.

The controller may be configured to: compare the estimated depth of the transparent obstacle with a collision range of a robot, control, based on the estimated depth being within the collision range, the robot to prevent a collision of the robot with the transparent obstacle, and control, based on the estimated depth being out of the collision range, the robot to normally drive.

The controller may be configured to: extract an RGB camera parameter and a depth camera parameter from the RGB-Depth camera, through camera calibration; extract a thermal imaging camera parameter from the thermal imaging camera; and by using the extracted RGB camera parameter, the extracted depth camera parameter, and the extracted thermal imaging camera parameter, generate the aligned at least one image and the aligned thermal image.

The controller may be configured to: align a depth image of the RGB-Depth camera and an RGB image of the RGB-Depth camera to generate the at least one image; and align the at least one image and the thermal image, to generate an aligned RGB image, an aligned depth image, and the aligned thermal image.

The controller may be configured to: extract, via a deep learning model, a feature of each of an aligned RGB image of the RGB-Depth camera and an aligned thermal image of the RGB-Depth camera, extract, based on the extracted feature, regions where different images are formed as the pixel region, and detect pixels of the pixel region as the transparent obstacle.

The controller may be configured to: divide the pixel region into a plurality of groups by using a clustering algorithm, and detect, from the plurality of groups, a lower outer boundary line close to a bottom surface.

The controller may be configured to stop, based on the lower outer boundary line not being detected, the estimation of the depth of the transparent obstacle.

The controller may be configured to estimate, based on the lower outer boundary line being detected, the depth of the transparent obstacle, and wherein the depth of the transparent obstacle is estimated based on: camera space information comprising a location of the thermal imaging camera and a direction of the thermal imaging camera; and a depth error value measured in a depth image of the RGB-Depth camera.

The controller may be configured to: determine, based on the lower outer boundary line being detected, a depth average of pixels having a same specific coordinate value as the pixel region among adjacent pixels below the lower outer boundary line as a depth of the bottom surface, and estimate the determined depth of the bottom surface as the depth of the transparent obstacle.

The controller may be configured to send, based on the pixel region not being detected, an inquiry for a depth with respect to pixels of pixel regions that are not determined as the transparent obstacle through an aligned depth image of the RGB-Depth camera.

A method for detecting a transparent obstacle may comprise synchronizing a red-green-blue-depth (RGB-Depth) camera and a thermal imaging camera; aligning red-green-blue (RGB) image and a depth image generated by the RGB-Depth camera with a thermal image generated by the thermal imaging camera, to generate an aligned RGB image, an aligned depth image, and an aligned thermal image, wherein each of the aligned RGB image, the aligned depth image, and the aligned thermal image is associated with the transparent obstacle; detecting, based on the aligned RGB image and the aligned thermal image, a pixel region determined as the transparent obstacle by using an artificial intelligence model; and estimating, based on the detected pixel region and based on the aligned depth image, a depth of the transparent obstacle.

The method may further comprise comparing the estimated depth of the transparent obstacle with a collision range of a robot; controlling, based on the estimated depth being within the collision range, the robot to stop; and controlling, based on the estimated depth being out of the collision range, the robot to normally drive.

The method may further comprise extracting an RGB camera parameter and a depth camera parameter from the RGB-Depth camera, through camera calibration; extracting a thermal imaging camera parameter from the thermal imaging camera; and by using the extracted RGB camera parameter, the extracted depth camera parameter, and the extracted thermal imaging camera parameter, generating the aligned RGB image, the aligned depth image, and the aligned thermal image.

The aligning the RGB image and the depth image with the thermal image may comprise: aligning the depth image with the RGB image; and aligning the aligned depth image and the aligned RGB image with the thermal image, to generate the aligned RGB image, the aligned depth image, and the aligned thermal image.

The detecting the pixel region determined as the transparent obstacle may comprise: extracting, via a deep learning model, a feature of each of the aligned RGB image and the aligned thermal image; extracting, based on the extracted feature, regions where different images are formed as the pixel region; and detecting pixels of the pixel region as the transparent obstacle.

The estimating the depth of the transparent obstacle may comprise: dividing the pixel region into a plurality of groups by using a clustering algorithm; and detecting, from the plurality of groups, a lower outer boundary line close to a bottom surface.

The estimating the depth of the transparent obstacle may comprise: stopping, based on the lower outer boundary line not being detected, the estimation of the depth of the transparent obstacle.

The estimating the depth of the transparent obstacle may comprise: estimating, based on the lower outer boundary line being detected, the depth of the transparent obstacle, and wherein the depth of the transparent obstacle is estimated based on: camera space information comprising a location of the thermal imaging camera and a direction of the thermal imaging camera; and a depth error value measured in the depth image.

The estimating the depth of the transparent obstacle may comprise: determining, based on the lower outer boundary line being detected, a depth average of pixels with respect to adjacent pixels below the lower outer boundary line; applying the depth average to pixels having a same coordinate value as a specific coordinate value in the pixel region; and estimating a depth of the bottom surface as the depth of the transparent obstacle.

The method may further comprise sending, based on the pixel region not being detected, an inquiry for a depth with respect to pixels of pixel regions that are not determined as the transparent obstacle through the aligned depth image.

### BRIEF DESCRIPTION OF THE DRAWINGS

FIG. 1 shows an example of an apparatus for detecting a transparent obstacle based on artificial intelligence according to an example.

FIG. 2, FIG. 3, FIG. 4, and FIG. 5 show examples of a method for detecting a transparent obstacle based on artificial intelligence according to an example.

FIG. 6 shows an example of a drawing for showing a computing device according to an example.

### DETAILED DESCRIPTION

An example of the disclosure will be described more fully hereinafter with reference to the accompanying drawings such that a person skill in the art may easily implement the example. As those skilled in the art would realize, the described examples may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition or alternative, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, examples of the present disclosure will be described with reference to the drawings.

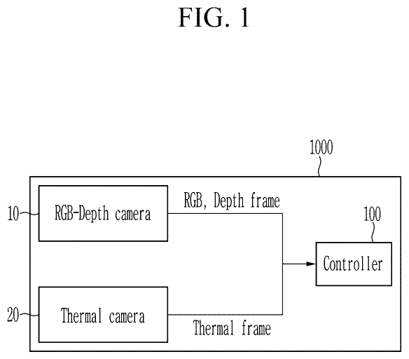

FIG. 1 shows an example of an apparatus for detecting a transparent obstacle based on artificial intelligence according to an example.

An apparatus 1000 for detecting a transparent obstacle, for example, based on artificial intelligence may be applied to a mobile robot and/or any mobility device (e.g., a vehicle, a drone, an autonomous vehicle, etc.). For example, the mobile robot may detect a transparent obstacle such as a glass door through the apparatus 1000 for detecting a transparent obstacle based on artificial intelligence, while driving.

The apparatus 1000 for detecting a transparent obstacle based on artificial intelligence may use an RGB-depth camera and a thermal imaging camera together for detection of a transparent obstacle. The apparatus 1000 for detecting a transparent obstacle based on artificial intelligence may detect the transparent glass within the image by using a difference between the RGB image and the thermal image.

The apparatus 1000 for detecting a transparent obstacle based on artificial intelligence may comprise a vision system including an RGB-depth camera and a thermal imaging camera, and may detect the transparent obstacle from the image by using the artificial intelligence. The apparatus 1000 for detecting a transparent obstacle based on artificial intelligence may send (e.g., transmit) a stop or drive command to the robot, for example, based on the detected transparent obstacle.

FIG. 1 shows an example of a configuration of an apparatus for detecting a transparent obstacle based on artificial intelligence, which includes a controller linked with a vision system.

Referring to FIG. 1, the apparatus 1000 for detecting a transparent obstacle based on artificial intelligence may include an RGB-Depth (RGBD) camera 10, a thermal imaging camera 20 and a controller 100.

The vision system may include the RGB-depth camera 10 and the thermal imaging camera 20.

The RGB-depth camera 10 may generate RGB images and/or depth images through photographing.

The RGB image may include color information of an object. The depth image may include distance information from each pixel of an object to the camera. The depth image may be needed for alignment between the RGB image and the thermal image, and may be used for depth estimation of the transparent obstacle, for example, as auxiliary information.

The thermal imaging camera 20 may generate the thermal image. The thermal image may show temperature distribution of an object.

The RGB-depth camera 10 and the thermal imaging camera 20 may be fixed to each other. Photographing directions of the RGB-depth camera 10 and the thermal imaging camera 20 may be parallel to each other. For example, a center of the lens of the thermal imaging camera 20 may be located, for example, about 25 mm above a center of an RGB camera 10.

The RGB-depth camera 10 and the thermal imaging camera 20 may send (e.g., transmit) frames of simultaneously photographed images to the controller 100 connected thereto, respectively.

The controller 100 may be connected to the RGB-depth camera 10 and the thermal imaging camera 20 synchronized with each other.

The controller 100 may be mounted on the mobile robot, and for driving algorithm operation, the controller 100 may be provided in a plural quantity. For operation of the present disclosure, at least one controller 100 may be needed.

The controller 100 may convert the photographed frame to be used as an input for a deep learning model and may operate the transparent obstacle detection algorithm to estimate the transparent obstacle by using the deep learning model.

The controller 100 may align the RGB image and the depth image with respect to the thermal image, and may generate an aligned RGB image, an aligned depth image, and an aligned thermal image.

The controller 100 may detect a pixel region determined as the transparent obstacle by using the artificial intelligence model based on the aligned RGB image and/or the aligned thermal image.

If the pixel region determined as the transparent obstacle is detected, the controller 100 may estimate the depth of the transparent obstacle by using the aligned depth image and/or the detected pixel region.

The controller 100 may improve detection performance for the transparent obstacle such as glass by effectively modeling a difference between the RGB image and the thermal image through the deep learning model.

The controller 100 may compare the estimated depth of the transparent obstacle with a collision range predetermined in the robot that may be currently driving.

If the estimated depth is within the collision range, the controller 100 may stop the robot. IF the estimated depth is out of the collision range, the controller 100 may control the robot to normally drive.

The controller 100 may extract a RGB camera parameter and a depth camera parameter from the RGB-Depth camera, through camera calibration, and may extract a thermal imaging camera parameter from the thermal imaging camera.

The controller 100 may generate the aligned RGB image, the aligned depth image, and/or the aligned thermal image by using the extracted the RGB camera parameter, the depth camera parameter, and/or the thermal imaging camera parameter.

The controller 100 may generate a primarily aligned depth image and a primarily aligned RGB image by primarily aligning the depth image with respect to the RGB image.

The controller 100 may generate the aligned RGB image, the aligned depth image, and/or the aligned thermal image by finally aligning the primarily aligned depth image and the primarily aligned RGB image with respect to the thermal image, respectively.

The controller 100 may extract a feature of each of the aligned RGB image and the aligned thermal image through the deep learning model.

The controller 100 may extract regions where different images may be formed in the image as pixel regions based on each extracted feature and may detect the pixels of the extracted pixel region as the transparent obstacle.

The controller 100 may divide the pixel region into a plurality of groups by using a clustering algorithm, and may detect a lower outer boundary line close to a bottom, from the plurality of groups.

If the lower outer boundary line is not detected, the controller 100 may stop the estimation of depth with respect to the transparent obstacle.

If the lower outer boundary line is detected, the controller 100 may estimate an actual depth of the transparent obstacle based on camera space information including the location and direction of the thermal imaging camera and an incorrect depth value measured in the depth image.

If the lower outer boundary line is detected, the controller 100 may calculate a depth average of pixels having the same specific coordinate value as the pixel region among adjacent pixels below the lower outer boundary line as a depth of a bottom surface. The controller 100 may estimate the calculated depth of the bottom surface as the depth of the transparent obstacle.

If the pixel region determined as the transparent obstacle is not detected, the controller 100 may inquire an actual depth with respect to pixels of pixel regions that is not determined as the transparent obstacle through the aligned depth image.

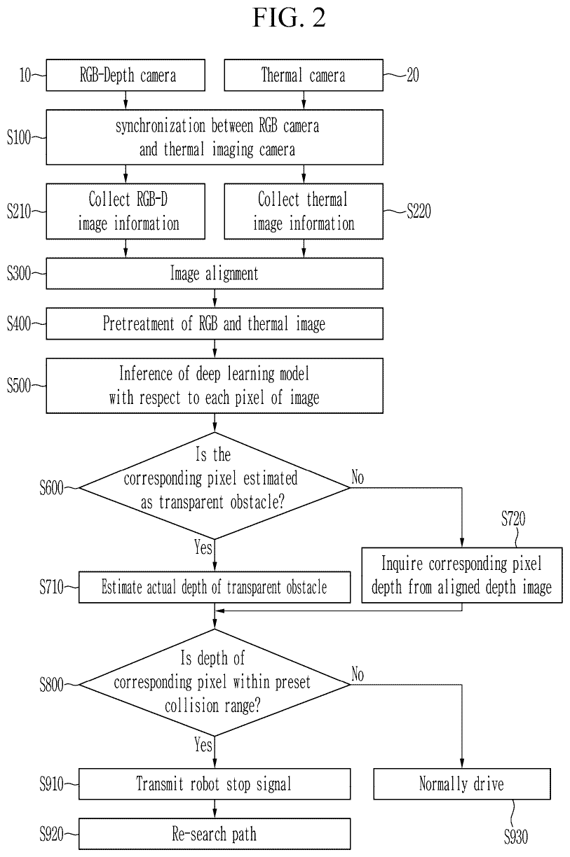

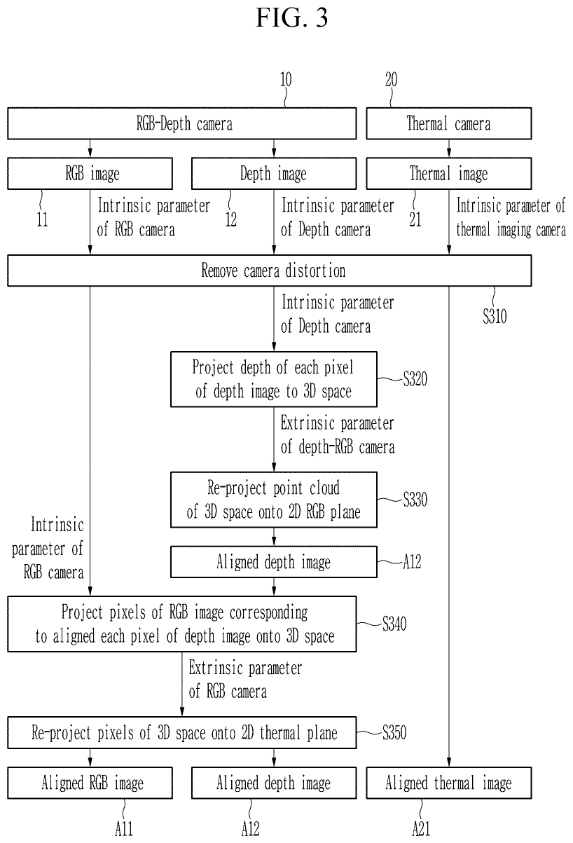

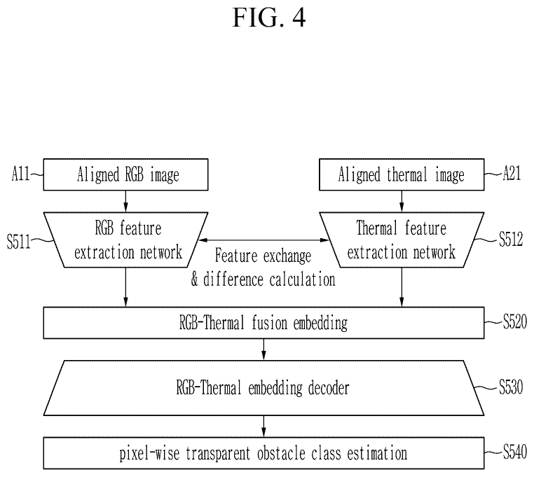

FIG. 2 to FIG. 5 show examples of a method for detecting a transparent obstacle based on artificial intelligence according to an example. A method for detecting a transparent obstacle based on artificial intelligence of FIG. 2 to FIG. 5 may be performed through the apparatus 1000 for detecting a transparent obstacle based on artificial intelligence of FIG. 1.

FIG. 2 shows an example of a method for detecting a transparent obstacle based on artificial intelligence according to an example. FIG. 2 shows an example of a scenario in which the mobile robot through the present disclosure may detect and detour around the transparent obstacle (e.g., glass) if driving.

The glass may be a representative example of the transparent obstacle, and the transparent obstacle of the present disclosure is not particularly limited to the glass, and may be the concept covering all transparent objects including glass.

In more detail, FIG. 2 shows an example process where the apparatus 1000, which may detect a transparent obstacle based on artificial intelligence, may photograph or capture the image frames through the RGB-depth camera 10 and the thermal imaging camera 20, estimate the region where the transparent obstacle exists by using this as the input of the deep learning model, and issue a command to the robot to detour around the transparent obstacle based on the estimation result.

In FIG. 2, at step S100, the apparatus 1000 for detecting a transparent obstacle based on artificial intelligence may synchronize the two cameras (e.g., that the RGB-depth camera 10 and the thermal imaging camera 20) and/or may photograph or capture frames at the same time.

For example, the apparatus 1000 for detecting a transparent obstacle based on artificial intelligence may synchronize the RGB-depth camera 10 and the thermal imaging camera 20 by connecting cables to a sync board or each other, or may measure and adjust the photographing time.

At step S300, if the RGB-depth camera 10 and the thermal imaging camera 20 photograph or capture the frame, the apparatus 1000 for detecting a transparent obstacle based on artificial intelligence may match and align the RGB image, the depth image and the thermal images to have the same screen coordinates.

The apparatus 1000 for detecting a transparent obstacle based on artificial intelligence may align the RGB image and the depth image generated by the RGB-depth camera with respect to the thermal image generated by the thermal imaging camera, and may generate the aligned RGB image, the aligned depth image and the aligned thermal image. The alignment process will be described in detail with reference to FIG. 3.

At step S400, the apparatus 1000 for detecting a transparent obstacle based on artificial intelligence may perform pretreatment in order to use the aligned RGB image, the aligned depth image, and the aligned thermal image as input data for the deep learning model. For example, the pretreatment may comprise one or more processing steps that may be applied to data before the data may be used in a particular application, such as a deep learning model. The one or more processing steps may ensure the data is in the right format and/or quality for the intended analysis or usage. For example, the pretreatment may comprise operations such as normalization, alignment, noise reduction, and other adjustments to make the RGB, depth, and thermal images suitable as input for the deep learning model.

For example, the apparatus 1000 for detecting a transparent obstacle based on artificial intelligence may correct data through normalization, form conversion, or the like with respect to each image.

At step S500, the apparatus 1000 for detecting a transparent obstacle based on artificial intelligence may perform estimation through the artificial intelligence model with respect to each pixel of the images. For example, after the pretreatment, the apparatus 1000 for detecting a transparent obstacle based on artificial intelligence may detect the pixel region determined as the transparent obstacle by using the deep learning model based on the aligned RGB image and the aligned thermal image.

The deep learning model may receive the aligned RGB image and the aligned thermal image as the input, and according to a model weight value, may output the transparent obstacle estimation probability associated with each pixel region of the input images as a result arrangement of the input image size. The deep learning model may perform image segmentation, and may be provided as a model trained in advance through data of the transparent obstacle.

For example, if the transparent obstacle estimation probability for each pixel is a predetermined value (e.g., 0.5) or more, the apparatus 1000 for detecting a transparent obstacle based on artificial intelligence may determine the corresponding pixel as the transparent obstacle.

The apparatus 1000 for detecting a transparent obstacle based on artificial intelligence may determine that the transparent obstacle exists in the pixel region where the pixels having the estimation probability of the predetermined value or more are disposed. For example, the apparatus 1000 for detecting a transparent obstacle based on artificial intelligence may determine that all pixels of the pixel region may comprise the transparent obstacle. This will be described in detail with reference to FIG. 3.

At step S600, the apparatus 1000 for detecting a transparent obstacle based on artificial intelligence may determine whether the pixel region estimated as the transparent obstacle is detected.

The apparatus 1000 for detecting a transparent obstacle based on artificial intelligence may determine the transparent obstacle according to whether the pixel of which the transparent obstacle estimation probability is the predetermined value or above exists.

At step S710, if the pixel region is estimated as the transparent obstacle, the apparatus 1000 for detecting a transparent obstacle based on artificial intelligence may estimate the actual depth of the transparent obstacle.

For example, if the pixel region determined as the transparent obstacle is detected, the apparatus 1000 for detecting a transparent obstacle based on artificial intelligence may estimate the depth of the transparent obstacle by using the aligned depth image and the pixel region. This process will be described in detail with reference to FIG. 5.

At step S720, if the pixel region is not estimated as the transparent obstacle, the apparatus 1000 for detecting a transparent obstacle based on artificial intelligence may inquire the corresponding pixel depth from the aligned depth image.

Through this process, the apparatus 1000 for detecting a transparent obstacle based on artificial intelligence may correct the incorrect depth value of the transparent obstacle region in the aligned depth image and perform the collision detection more accurately.

At step S800, the apparatus 1000 for detecting a transparent obstacle based on artificial intelligence may determine whether the depth of the pixel of the pixel region estimated as the transparent obstacle is within the preset collision range of the robot. At step S910, if the depth of the corresponding pixel is closer than the collision range (e.g., the collision range is 1 m), the apparatus 1000 for detecting a transparent obstacle based on artificial intelligence may transmit a robot stop signal in order to stop the robot. The apparatus 1000 for detecting a transparent obstacle based on artificial intelligence may display a warning on a screen for monitoring the driving.

Thereafter, at step S920, the apparatus 1000 for detecting a transparent obstacle based on artificial intelligence may re-search for a path for detouring the obstacle ahead.

At step S930, if no obstacle exists ahead within the collision range, the apparatus 1000 for detecting a transparent obstacle based on artificial intelligence may transmit a signal to the robot to normally drive along the path.

All steps of FIG. 2 may be performed in real time, and while the robot is driving, the apparatus 1000 for detecting a transparent obstacle based on artificial intelligence may repeatedly operate.

FIG. 3 shows an example of a flowchart showing details of the image aligning step (step S300) of FIG. 2 according to an example.

In FIG. 3, the apparatus 1000 for detecting a transparent obstacle based on artificial intelligence may extract the RGB camera parameter (e.g., focal length, aperture, shutter speed, ISO sensitivity, white balance, and/or resolution, etc.) and the depth camera parameter (e.g., baseline distance, depth resolution, field of view, and/or minimum and maximum depth range, etc.) from the RGB-depth camera 10, through camera calibration, and may extract the thermal imaging camera parameter (e.g., thermal sensitivity, resolution, field of view, and/or temperature range, etc.) from the thermal imaging camera 20.

The apparatus 1000 for detecting a transparent obstacle based on artificial intelligence may obtain camera parameters between Depth and RGB images, and between RGB and thermal images, prior to the driving of the robot.

The apparatus 1000 for detecting a transparent obstacle based on artificial intelligence may generate an aligned RGB image A11, an aligned depth image A12 and an aligned thermal image A21 by using the extracted RGB camera parameter, the extracted depth camera parameter and the extracted thermal imaging camera parameter. For example, the parameter may include intrinsic parameters and extrinsic parameters.

For a perfect alignment, information on the position and/or distance of the subject may be required, and a photographed depth image 12 may perform the role.

The apparatus 1000 for detecting a transparent obstacle based on artificial intelligence may, in order to align the RGB image 11 to the thermal image 21, align the depth image 12 to the RGB image 11, and then align the aligned depth image A12 and the aligned RGB image A11 to the thermal image 21, thereby obtaining the aligned thermal image A21.

At step S310, the apparatus 1000 for detecting a transparent obstacle based on artificial intelligence may first remove distortion from images including the RGB image 11, the depth image 12 and the thermal image 21 through intrinsic parameters of the RGB camera, intrinsic parameters of the Depth camera, intrinsic parameters of the thermal imaging camera.

At step S320, in order to align the depth image 12 with the RGB image 11, the apparatus 1000 for detecting a transparent obstacle based on artificial intelligence may calculate the depth of each pixel of the depth image 12 with an intrinsic parameter matrix of the depth camera and project it to a 3D space.

At step S330, in order to match the depth image 12 to the RGB coordinate, the apparatus 1000 for detecting a transparent obstacle based on artificial intelligence may re-project the point cloud projected to the 3D space to a 2D RGB plane, through calculation with the camera extrinsic parameter matrix of depth and RGB.

Through the process, the apparatus 1000 for detecting a transparent obstacle based on artificial intelligence may obtain the aligned depth image A12 on an RGB coordinate plane.

The apparatus 1000 for detecting a transparent obstacle based on artificial intelligence may perform similar processes in order to match the RGB image 11 with the coordinate plane of the thermal image 21.

At step S340, for example, the apparatus 1000 for detecting a transparent obstacle based on artificial intelligence may project pixels of the RGB image 11 corresponding to each pixel of the aligned depth image A12 to the 3D space.

The apparatus 1000 for detecting a transparent obstacle based on artificial intelligence may project the aligned depth image A12 aligned with the RGB image 11 to the 3D space again by using an intrinsic parameter matrix of the RGB camera. Each point of a projected point cloud may have a color value of the corresponding RGB image 11.

At step S350, the apparatus 1000 for detecting a transparent obstacle based on artificial intelligence may re-project pixels of the 3D space to a 2D thermal plane.

The apparatus 1000 for detecting a transparent obstacle based on artificial intelligence may re-project the point cloud of the 3D space to the 2D thermal plane by using the extrinsic parameter of the RGB-thermal imaging camera, and may obtain the aligned RGB image A11 and the aligned depth image A12 aligned with the thermal image 21. The thermal image 21 may be considered as the aligned thermal image A21.

FIG. 4 shows an example of a flowchart showing details of the deep learning model inference step (step S500) of FIG. 2 according to an example.

In FIG. 4, at step S511 and S512, the apparatus 1000 for detecting a transparent obstacle based on artificial intelligence may extract a feature (e.g., regions, edges, textures, shapes, color patterns, and/or thermal signatures, etc.) of each of the aligned RGB image A11 and the aligned thermal image A21 through the deep learning model.

For example, the apparatus 1000 for detecting a transparent obstacle based on artificial intelligence may extract regions where different images may be formed as the pixel region of the transparent obstacle based on each extracted feature, and may detect the pixels of the extracted pixel region as the transparent obstacle.

The deep learning model for detecting the transparent obstacle may operate based on the optical characteristic difference between the RGB camera and the thermal imaging camera. For example, the optical characteristic difference may refer to the distinct methods by which the RGB camera may capture visible light and color, and the thermal imaging camera may capture infrared radiation and temperature differences.

For example, the wavelength of the visible ray used by RGB camera may be about 0.4 μm to 0.7 μm, and the LWIR used by the thermal imaging camera may have the wavelength of 8 μm to 14 μm.

Transparent obstacles such as glass and plastic typically may allow light with a wavelength of 4 μm or less to pass through. If glass is photographed by an RGB camera, light passes through, allowing objects behind it to be observed. These objects may not be visible to the thermal imaging camera.

The apparatus 1000 for detecting the transparent obstacle based on artificial intelligence may analyze each image through the deep learning model, and may distinguish the difference in the images to estimate pixels in different regions as the transparent obstacle.

As an inference process of deep learning, the apparatus 1000 for detecting a transparent obstacle based on artificial intelligence may receive the aligned RGB image A1 and the aligned thermal image A21 as inputs, and analyze and compare the features of each image to detect or estimate the transparent obstacle on a pixel-wise basis.

For example, at steps S511 and S512, the apparatus 1000 for detecting a transparent obstacle based on artificial intelligence may extract the features with respect to the aligned RGB image A11 and the aligned thermal image A21 through respective networks. During this process, at step S520, the apparatus 1000 for detecting a transparent obstacle based on artificial intelligence may exchange features, calculate a difference for each feature, compare the two images, and thereby embed feature vectors including information on the region where different images are formed. This step may be repeatedly performed depending on the network structure.

At step S530, the apparatus 1000 for detecting a transparent obstacle based on artificial intelligence may use an embedding decoder network in which the features of the aligned RGB image A11 and the aligned thermal image A21 are mixed.

For example, by mixing the detailed color and texture information from the aligned RGB image A11 with the temperature-based data from the aligned thermal image A21, the embedding decoder network may create a comprehensive feature map that enhances transparent obstacle detection. This mixing may allow the system to detect transparent obstacles, such as glass, that may be visible in the RGB image but lack distinct thermal signatures. The mixed features may provide a more robust input for the deep learning model, enabling it to accurately identify and locate transparent obstacles in various environmental conditions.

At step S540, the apparatus 1000 for detecting a transparent obstacle based on artificial intelligence perform the transparent obstacle class estimation on the pixel-wise basis by applying deep learning network.

FIG. 5 shows an example of a flowchart showing details of the step (step S710) of estimating the actual depth of the transparent obstacle of FIG. 2 according to an example. FIG. 5 shows an example process of estimating the actual depth of the pixel region of the transparent obstacle through the pixel-wise transparent obstacle estimation result.

In FIG. 5, the apparatus 1000 for detecting a transparent obstacle based on artificial intelligence may use the aligned depth image aligned to the thermal image and the pixel-wise transparent obstacle estimation result PC, in estimating the depth of the pixel region of the transparent obstacle. The pixel-wise transparent obstacle estimation result PC may include the pixel region where pixels estimated as the transparent obstacle are disposed.

By not detecting the transparent obstacle due to sensor limitations, the aligned depth image A12 may have the incorrect depth value in the transparent obstacle region (the pixel region where the transparent obstacle exists).

For example, the transparent obstacle including a glass window is mostly in the form of a rectangular-shaped plane and may be fixed to the bottom or adjacent to the bottom. The apparatus 1000 for detecting a transparent obstacle based on artificial intelligence may estimate the actual depth of the transparent obstacle fixed to the bottom.

At step S711, the apparatus 1000 for detecting a transparent obstacle based on artificial intelligence may divide the pixel region obtained by the transparent obstacle estimation result into a plurality of groups by using a clustering algorithm (e.g., K-means, Density-Based Spatial Clustering of Applications with Noise (DBSCAN), hierarchical clustering, Mean Shift, Affinity Propagation, Gaussian Mixture Models (GMM), Spectral Clustering, Agglomerative Clustering, Ordering Points To Identify the Clustering Structure (OPTICS), Balanced Iterative Reducing and Clustering using Hierarchies (BIRCH), or any other suitable algorithm, etc.).

At step S712, the apparatus 1000 for detecting a transparent obstacle based on artificial intelligence may detect an outer boundary line below the group region of the plurality of groups by using a detection algorithm (e.g., Canny edge detector, Sobel operator, Hough transform, Laplacian of Gaussian (LoG), Fast Region-based Convolutional Neural Network (Fast R-CNN), Mask Region-based Convolutional Neural Network (Mask R-CNN), You Only Look Once (YOLO), or the Region-based Convolutional Neural Network (R-CNN), and any other suitable algorithm, etc.).

At step S713, if the outer boundary line is not detected, the apparatus 1000 for detecting a transparent obstacle based on artificial intelligence may stop the actual depth estimation of the transparent obstacle, as there may be a high possibility that an obstacle closer than the glass exists.

At step S714, if the outer boundary line is not detected, the apparatus 1000 for detecting a transparent obstacle based on artificial intelligence may search for the pose information (e.g., position information within the space) of each camera in order to correctly correct the mistakenly photographed depth of the pixel region of the transparent obstacle.

The apparatus 1000 for detecting a transparent obstacle based on artificial intelligence may perform measurement by using an inertial measurement unit (IMU) sensor (e.g., accelerometers, gyroscopes, magnetometers, etc.), or if the pose information of each camera exists and the camera is fixed, the angle of the actual transparent obstacle (e.g., glass window) may be obtained based on the pose information of the camera.

If the lower outer boundary line is detected, the apparatus 1000 for detecting a transparent obstacle based on artificial intelligence may estimate the actual depth of the transparent obstacle based on camera space information including the location and direction of the thermal imaging camera and a depth error value with respect to the transparent obstacle measured by the aligned depth image A12.

At step S715, the apparatus 1000 for detecting a transparent obstacle based on artificial intelligence may obtain the pose information in the transparent obstacle plane by calculating the norm vector of the transparent obstacle by using trigonometric calculations based on the camera's space information and the incorrect depth value measured by the depth camera, and based on this, may calculate the correct depth value of the transparent obstacle region.

The apparatus 1000 for detecting a transparent obstacle based on artificial intelligence may approximate the actual depth value of the transparent obstacle pixel region by using pixels adjacent to the pixel region of the transparent obstacle, even if the camera's space information is not available.

For example, if the lower outer boundary line is detected, the apparatus 1000 for detecting a transparent obstacle based on artificial intelligence may calculate a depth average with respect to the specific coordinate value adjacent pixels below the lower outer boundary line.

The apparatus 1000 for detecting a transparent obstacle based on artificial intelligence may apply the calculated depth average to the pixels having the same coordinate value as the specific coordinate value in the pixel region.

The apparatus 1000 for detecting a transparent obstacle based on artificial intelligence may estimate the depth of the bottom surface as the actual depth of the transparent obstacle.

At step S716, the apparatus 1000 for detecting a transparent obstacle based on artificial intelligence may calculate the average depth of pixels adjacent to the outer boundary line below the transparent obstacle pixel region, according to their y-coordinate values.

At step S717, the apparatus 1000 for detecting a transparent obstacle based on artificial intelligence may propagate the calculated average to the transparent obstacle pixel region having the same y-coordinate value, and replace the depth of the transparent obstacle pixel region according to the y-coordinate values with the average depth of pixels on the bottom surface to which the transparent obstacle is fixed.

At step S718, the apparatus 1000 for detecting a transparent obstacle based on artificial intelligence may estimate the depth of the transparent obstacle pixel region based on the calculation result.

The apparatus 1000 for detecting a transparent obstacle based on artificial intelligence may estimate that the transparent obstacle pixel region has the same depth as the bottom surface, and based on this, control the robot to detour around the transparent obstacle that is fixed to the bottom during navigation.

The apparatus 1000 for detecting a transparent obstacle based on artificial intelligence according to an example may effectively detect and detour around transparent obstacles such as glass, which may not be detected by depth cameras and LiDAR, if the robot is driving in either of indoor and outdoor environments. For example, the apparatus 1000 for detecting a transparent obstacle based on artificial intelligence may detect obstacles such as glass swing doors, revolving doors, automatic doors, glass walls, or the like.

The apparatus 1000 for detecting a transparent obstacle based on artificial intelligence may greatly reduce the risk of collisions in buildings with a lot of glass, such as hotels.

The apparatus 1000 for detecting a transparent obstacle based on artificial intelligence may also be applied to functions such as person detection, fire detection, or the like, using the same sensors (e.g., camera, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.).

The apparatus 1000 for detecting a transparent obstacle based on artificial intelligence may detect transparent objects as obstacles during generation of environment maps using a mobile robot, enabling the generation of maps capable of more accurately determining whether it is drivable.

The apparatus 1000 for detecting a transparent obstacle based on artificial intelligence may also be utilized for data collection using a mobile robot, and by using the vision system, RGB, depth, and thermal images may be easily photographed and/or collected.

An apparatus for detecting a transparent obstacle based on artificial intelligence may include an RGB-Depth camera configured to generate an RGB image and a depth image, a thermal imaging camera configured to generate a thermal image, and a controller connected to the RGB-depth camera and the thermal imaging camera synchronized with each other, where the controller may be configured to align the RGB image and the depth image with respect to the thermal image, to generate an aligned RGB image, an aligned depth image and an aligned thermal image, detect a pixel region determined as the transparent obstacle by using an artificial intelligence model based on the aligned RGB image and the aligned thermal image, and estimate the depth of the transparent obstacle by using the aligned depth image and the detected pixel region if the pixel region determined as the transparent obstacle is detected.

The controller may be configured to compare the estimated depth of the transparent obstacle with a collision range predetermined in the robot that is currently driving, stop control the robot if the depth is within the collision range, and control the robot to normally drive if the depth is out of the collision range.

The controller may be configured to extract an RGB camera parameter and depth camera parameter from the RGB-Depth camera, through camera calibration, and extract the thermal imaging camera parameter from the thermal imaging camera, and generate the aligned RGB image, the aligned depth image and the aligned thermal image by using the extracted RGB camera parameter, the extracted depth camera parameter and the extracted thermal imaging camera parameter.

The controller may be configured to primarily align the depth image with respect to the RGB image to generate primarily aligned depth image and primarily aligned RGB image, and finally align the primarily aligned depth image and the primarily aligned RGB image with respect to the thermal image, respectively, to generate the aligned RGB image, the aligned depth image and the aligned thermal image.

The controller may be configured to extract a feature of each of the aligned RGB image and the aligned thermal image through a deep learning model, extract regions where different images are formed as the pixel region based on the extracted feature, and detect pixels of the extracted pixel region as the transparent obstacle.

The controller may be configured to divide the pixel region into a plurality of groups by using a clustering algorithm, and detect a lower outer boundary line close to a bottom surface, from the plurality of groups.

If the lower outer boundary line is not detected, the controller may be configured to stop the estimation of the depth with respect to the transparent obstacle.

If the lower outer boundary line is detected, the controller may be configured to estimate the depth of the transparent obstacle based on camera space information including the location and/or direction of the thermal imaging camera and/or a depth error value measured in the depth image.

If the lower outer boundary line is detected, the controller may be configured to calculate a depth average of the pixels having the same specific coordinate value as the pixel region among adjacent pixels below the lower outer boundary line as depth of the bottom surface, and estimate the calculated depth of the bottom surface as depth of the transparent obstacle.

If the pixel region determined as the transparent obstacle is not detected, the controller may be configured to inquire a depth with respect to pixels of pixel regions that may not be determined as the transparent obstacle through the aligned depth image.

A method for detecting a transparent obstacle based on artificial intelligence may include synchronizing an RGB-Depth camera and a thermal imaging camera, aligning an RGB image and a depth image generated by the RGB-depth camera with respect to a thermal image generated by the thermal imaging camera, to generate an aligned RGB image, aligned depth image and an aligned thermal image, pretreating the aligned RGB image, the aligned depth image and the aligned thermal image, detecting a pixel region determined as the transparent obstacle by using an artificial intelligence model based on the aligned RGB image and the aligned thermal image after the pretreating, and estimating the depth of the transparent obstacle by using the aligned depth image and the pixel region, if the pixel region determined as the transparent obstacle is detected.

A method for detecting a transparent obstacle based on artificial intelligence may further include compare the estimated depth of the transparent obstacle with a collision range predetermined in the robot that is currently driving, controlling the robot to stop if the depth is within the collision range, and controlling the robot to normally drive if the depth is out of the collision range.

The aligning the RGB image and the depth image with respect to the thermal image may further include extracting an RGB camera parameter and a depth camera parameter from the RGB-Depth camera, through camera calibration and extracting a thermal imaging camera parameter from the thermal imaging camera, and generating the aligned RGB image, the aligned depth image and the aligned thermal image by using the extracted the RGB camera parameter, the extracted depth camera parameter and the extracted thermal imaging camera parameter.

The aligning the RGB image and the depth image with respect to the thermal image may further include primarily aligning the depth image with respect to the RGB image to generate a primarily aligned depth image and a primarily aligned RGB image, and finally aligning the primarily aligned depth image and the primarily aligned RGB image with respect to the thermal image, respectively, to generate the aligned RGB image, the aligned depth image and the aligned thermal image.

The detecting the pixel region determined as the transparent obstacle may further include extract a feature of each of the aligned RGB image and the aligned thermal image through a deep learning model, extract regions where different images are formed as the pixel region based on the extracted each feature, and detect pixels of the extracted pixel region as the transparent obstacle.

The estimating the depth of the transparent obstacle may further include dividing the pixel region into a plurality of groups by using a clustering algorithm, and detecting a lower outer boundary line close to a bottom surface, from the plurality of groups. The estimating the depth of the transparent obstacle may further include stopping the estimation of the depth with respect to the transparent obstacle if the lower outer boundary line is not detected.

The estimating the depth of the transparent obstacle may further include estimating the depth of the transparent obstacle based on camera space information including the location and direction of the thermal imaging camera and a depth error value measured in the depth image, if the lower outer boundary line is detected.

The estimating the depth of the transparent obstacle may further include calculate a depth average of specific coordinate values with respect to adjacent pixels below the lower outer boundary line, if the lower outer boundary line is detected, apply the calculated depth average to pixels having the same coordinate value as the specific coordinate value in the pixel region apply, and estimate the depth of the bottom surface as the actual depth of the transparent obstacle.

A method for detecting a transparent obstacle based on artificial intelligence may further include, if the pixel region determined as the transparent obstacle is not detected, inquiring a depth with respect to pixels of pixel regions that may not be determined as the transparent obstacle through the aligned depth image.

An apparatus and method for detecting a transparent obstacle based on artificial intelligence according to an example may effectively detect the transparent obstacles such as glass that may not be detected by the depth camera and/or LIDAR while the robot is driving.

An apparatus and method for detecting a transparent obstacle based on artificial intelligence according to an example may configure a vision system by using an RGB-depth camera and a thermal imaging camera, detect a transparent obstacle through a deep learning with an input of information obtained by the vision system, and enable a robot to detour around the detected transparent obstacle if applied to a mobile robot.

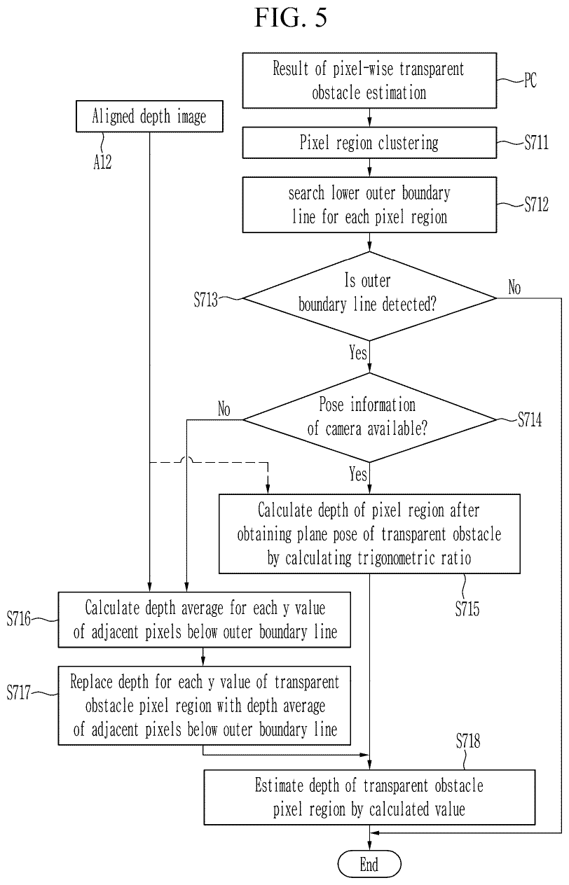

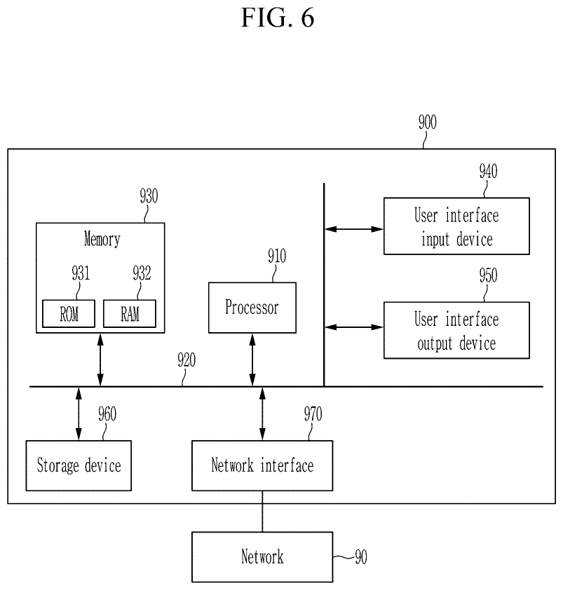

FIG. 6 show an example of a drawing for showing a computing device according to an example.

Referring to FIG. 6, a method and apparatus for detecting the transparent obstacle based on the artificial intelligence according to an example may be implemented by using a computing device 900.

The computing device 900 may include at least one of a processor 910, a memory 930, the user interface input device 940, the user interface output device 950 and a storage device 960 that communicate through a bus 920. For example, the storage device 960 may comprise a random-access memory (RAM), an embedded multi-media card (eMMC), a data scratch pad RAM (DSPR), a data local memory unit (DLMU), a local memory unit (LMU), or a default application memory (DAM), etc. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 6.

The memory 930 and the storage device 960 may include various types of volatile or non-volatile storage media. For example, the memory may include read-only memory (ROM) 931 and a random-access memory (RAM) 932. In this example, the memory 930 may be located inside or outside processor 910, and the memory 930 may be connected to the processor 910 through various known means.

In some examples, at least some configurations or functions of an apparatus and method for detecting a transparent obstacle based on artificial intelligence according to an example may be implemented as a program or software executable by the computing device 900, and program or software may be stored in a computer-readable medium.

In some examples, at least some configurations or functions of an apparatus and method for detecting a transparent obstacle based on artificial intelligence according to an example may be implemented by using hardware or circuitry of the computing device 900, or may also be implemented as separate hardware or circuitry that may be electrically connected to the computing device 900.

While this disclosure has been described in connection with what is presently considered to be practical examples, it is to be understood that the disclosure is not limited to the disclosed examples, but, on the contrary, is intended to cover various modifications and equivalent arrangements included within the spirit and scope of the appended claims.

What is claimed is:

1. An apparatus for detecting a transparent obstacle, the apparatus comprising:
a red-green-blue-depth (RGB-Depth) camera configured to generate at least one image associated with the transparent obstacle, wherein the at least one image comprises red-green-blue (RGB) data and depth data;
a thermal imaging camera configured to generate a thermal image associated with the transparent obstacle; and
a controller coupled to the RGB-depth camera and the thermal imaging camera synchronized with each other,
wherein the controller is configured to:
align the at least one image and the thermal image;
detect, based on the aligned at least one image and the aligned thermal image, a pixel region determined as the transparent obstacle by using an artificial intelligence model; and
estimate, based on the detected pixel region and based on the depth data of the aligned at least one image, a depth of the transparent obstacle.

2. The apparatus of claim 1, wherein the controller is configured to:
compare the estimated depth of the transparent obstacle with a collision range of a robot,
control, based on the estimated depth being within the collision range, the robot to prevent a collision of the robot with the transparent obstacle, and
control, based on the estimated depth being out of the collision range, the robot to normally drive.

3. The apparatus of claim 1, wherein the controller is configured to:
extract an RGB camera parameter and a depth camera parameter from the RGB-Depth camera, through camera calibration;
extract a thermal imaging camera parameter from the thermal imaging camera; and
by using the extracted RGB camera parameter, the extracted depth camera parameter, and the extracted thermal imaging camera parameter, generate the aligned at least one image and the aligned thermal image.

4. The apparatus of claim 1, wherein the controller is configured to:
align a depth image of the RGB-Depth camera and an RGB image of the RGB-Depth camera to generate the at least one image; and
align the at least one image and the thermal image, to generate an aligned RGB image, an aligned depth image, and the aligned thermal image.

5. The apparatus of claim 1, wherein the controller is configured to:
extract, via a deep learning model, a feature of each of an aligned RGB image of the RGB-Depth camera and an aligned thermal image of the RGB-Depth camera,
extract, based on the extracted feature, regions where different images are formed as the pixel region, and
detect pixels of the pixel region as the transparent obstacle.

6. The apparatus of claim 5, wherein the controller is configured to:
divide the pixel region into a plurality of groups by using a clustering algorithm, and
detect, from the plurality of groups, a lower outer boundary line close to a bottom surface.

7. The apparatus of claim 6, wherein the controller is configured to stop, based on the lower outer boundary line not being detected, the estimation of the depth of the transparent obstacle.

8. The apparatus of claim 6, wherein the controller is configured to estimate, based on the lower outer boundary line being detected, the depth of the transparent obstacle, and
wherein the depth of the transparent obstacle is estimated based on:
camera space information comprising a location of the thermal imaging camera and a direction of the thermal imaging camera; and
a depth error value measured in a depth image of the RGB-Depth camera.

9. The apparatus of claim 6, wherein the controller is configured to:
determine, based on the lower outer boundary line being detected, a depth average of pixels having a same specific coordinate value as the pixel region among adjacent pixels below the lower outer boundary line as a depth of the bottom surface, and
estimate the determined depth of the bottom surface as the depth of the transparent obstacle.

10. The apparatus of claim 1, wherein the controller is configured to send, based on the pixel region not being detected, an inquiry for a depth with respect to pixels of pixel regions that are not determined as the transparent obstacle through an aligned depth image of the RGB-Depth camera.

11. A method for detecting a transparent obstacle, the method comprising:
synchronizing a red-green-blue-depth (RGB-Depth) camera and a thermal imaging camera;
aligning red-green-blue (RGB) image and a depth image generated by the RGB-Depth camera with a thermal image generated by the thermal imaging camera, to generate an aligned RGB image, an aligned depth image, and an aligned thermal image, wherein each of the aligned RGB image, the aligned depth image, and the aligned thermal image is associated with the transparent obstacle;
detecting, based on the aligned RGB image and the aligned thermal image, a pixel region determined as the transparent obstacle by using an artificial intelligence model; and
estimating, based on the detected pixel region and based on the aligned depth image, a depth of the transparent obstacle.

12. The method of claim 11, further comprising:
comparing the estimated depth of the transparent obstacle with a collision range of a robot;
controlling, based on the estimated depth being within the collision range, the robot to stop; and
controlling, based on the estimated depth being out of the collision range, the robot to normally drive.

13. The method of claim 11, further comprising:
extracting an RGB camera parameter and a depth camera parameter from the RGB-Depth camera, through camera calibration;
extracting a thermal imaging camera parameter from the thermal imaging camera; and
by using the extracted RGB camera parameter, the extracted depth camera parameter, and the extracted thermal imaging camera parameter, generating the aligned RGB image, the aligned depth image, and the aligned thermal image.

14. The method of claim 11, wherein the aligning the RGB image and the depth image with the thermal image comprises:
aligning the depth image with the RGB image; and
aligning the aligned depth image and the aligned RGB image with the thermal image, to generate the aligned RGB image, the aligned depth image, and the aligned thermal image.

15. The method of claim 11, wherein the detecting the pixel region determined as the transparent obstacle comprises:
extracting, via a deep learning model, a feature of each of the aligned RGB image and the aligned thermal image;
extracting, based on the extracted feature, regions where different images are formed as the pixel region; and
detecting pixels of the pixel region as the transparent obstacle.

16. The method of claim 15, wherein the estimating the depth of the transparent obstacle comprises:
dividing the pixel region into a plurality of groups by using a clustering algorithm; and
detecting, from the plurality of groups, a lower outer boundary line close to a bottom surface.

17. The method of claim 16, wherein the estimating the depth of the transparent obstacle comprises:
stopping, based on the lower outer boundary line not being detected, the estimation of the depth of the transparent obstacle.

18. The method of claim 16, wherein the estimating the depth of the transparent obstacle comprises:
estimating, based on the lower outer boundary line being detected, the depth of the transparent obstacle, and
wherein the depth of the transparent obstacle is estimated based on:
camera space information comprising a location of the thermal imaging camera and a direction of the thermal imaging camera; and
a depth error value measured in the depth image.

19. The method of claim 16, wherein the estimating the depth of the transparent obstacle comprises:
determining, based on the lower outer boundary line being detected, a depth average of pixels with respect to adjacent pixels below the lower outer boundary line;
applying the depth average to pixels having a same coordinate value as a specific coordinate value in the pixel region; and
estimating a depth of the bottom surface as the depth of the transparent obstacle.

20. The method of claim 11, further comprising:
sending, based on the pixel region not being detected, an inquiry for a depth with respect to pixels of pixel regions that are not determined as the transparent obstacle through the aligned depth image.
